(19) United States
(12) Patent Application Publication
(10) Pub. No.: US 2017/0030098 A1
(43) Pub. Date: Feb. 2, 2017

(54) APPARATUS FOR IMPROVING SWIMMING POOL WATER CIRCULATION SYSTEM

(71) Applicants: George Gerard Brennan, Howell, NJ (US); Robert John Ellard, Middletown, NJ (US)

(72) Inventors: George Gerard Brennan, Howell, NJ (US); Robert John Ellard, Middletown, NJ (US)

(21) Appl. No.: 14/814,587

(22) Filed: Jul. 31, 2015

(51) Int. Cl. E04H 4/12; F16L 41/00

(52) U.S. Cl. CPC E04H 4/1209; F16L 41/00

(57) ABSTRACT

One embodiment of an apparatus for improving swimming pool water circulation includes a hollow body having a polyhedronal shape. The polyhedronal shape includes a plurality of faces. At least one port is affixed to one of faces. The port includes an inlet and an outlet. A fluid passage is thus defined through the hollow body and the at least one port.

### BACKGROUND OF THE INVENTION

Field of the Invention

Embodiments of the invention relate to an improved attachment for an existing swimming pool circulation system. The apparatus will replace a standard swimming pool directional diverter. The new apparatus will allow pressurized water to flow in a variety of different directions.

Background

Most in ground and above ground swimming pools have a system that circulates the water in a single direction. The existing system may have multiple diverter ports that try to circulate the water to force leaves and dirt debris to the surface of the water, so that the debris floats into a swimming pool skimmer filtering system. However, most of this debris does not reach the skimmer cleaning system and instead settles to the bottom of the swimming pool in dead zone areas where the existing water circulation system cannot reach. Even when adjusting the existing diverter port(s) of the existing system, one dead zone may disappear, but another dead zone will then appear.

Therefore, there is a need for an improved apparatus to help circulate the swimming pool water to agitate the bottom surface.

### SUMMARY OF THE INVENTION

One embodiment of an apparatus for improving swimming pool water circulation includes a hollow body having a polyhedronal shape. The polyhedronal shape includes a plurality of faces. At least one port is affixed to one of faces. The port includes an inlet and an outlet. A fluid passage is thus defined through the hollow body and the at least one port.

Another embodiment of an apparatus for improving swimming pool water circulation includes a body. The body includes a first planar base, a second planar base, and a plurality of planar sidewalls positioned between the first planar base and the second planar base, such that the first planar base, the second planar base, and the planar sidewalls collectively form a hollow polyhedron. A locking mechanism is affixed to the first planar base. A plurality of ports is affixed to the planar sidewalls. At least one port is affixed to the second planar base. Thus, a fluid passage is defined through the body and the ports.

Another embodiment of an apparatus for improving swimming pool water circulation includes a body. The body includes a first planar octagonal base, a second planar octagonal base, and a plurality of planar rectangular sidewalls positioned between the first planar octagonal base and the second planar octagonal base, such that the first planar octagonal base, the second planar octagonal base, and the planar rectangular sidewalls collectively form a hollow octagonal prism. A locking mechanism is affixed to the first planar octagonal base. A first plurality of ports is affixed to the planar rectangular sidewalls. A second plurality of ports is affixed to the second planar octagonal base. Thus, a fluid passage is defined through the body and the ports.

### BRIEF DESCRIPTION OF THE DRAWINGS

The description of the said invention can be described in conjunction with the detailed drawings, in which:

FIG. 1 is a perspective view of one embodiment of an apparatus for improving water circulation, according to the present invention;

FIG. 2 is another perspective view of the apparatus illustrated in FIG. 1;

FIG. 3 is a cross sectional view of the apparatus illustrated in FIG. 1;

FIG. 4 is a perspective view of a second embodiment of an apparatus for improving water circulation, according to the present invention; and

FIG. 5 is a cross sectional view of the apparatus illustrated in FIG. 4.

### DETAILED DESCRIPTION

Embodiments of the invention generally provide an apparatus such as a diverter that fastens to an existing piping mechanism system of a swimming pool. Embodiments of the apparatus include a hollow polyhedronal body having one or more ports that are attached to it. These ports are arranged at various locations throughout the polyhedronal body. The ports allow water to flow in different directions in the swimming pool once the apparatus is installed. In some embodiments, these ports also have one or more corrugated ridges on them to allow vinyl tubing or any other chemical ultraviolet (UV) resistant tubing of any length to be secured to the ports. Further embodiments of the invention include the tubing attached to the ports. In one example configuration, there are a total of seven ports attached to the body, although any number of ports may be used. The tubing that is attached to the ports may have different lengths (i.e., each piece of tubing need not necessarily be of the same length). Using tubing of different lengths allows the tubing to move freely through the water and against each other. The tubing can vary in length depending upon the swimming pool size. The apparatus will help to improve water circulation in the swimming pool and to reduce the occurrence of dead spots. Although embodiments of the invention are discussed within the context of improving water circulation in a swimming pool, it will be appreciated that the invention may be advantageously deployed in any body of water that uses a mechanical or electromechanical system to circulate the water (e.g., retention basins, decorative ponds, or the like). Some materials the body and ports can be comprised of are PCV, vinyl or any other material that is resistant to UV light.

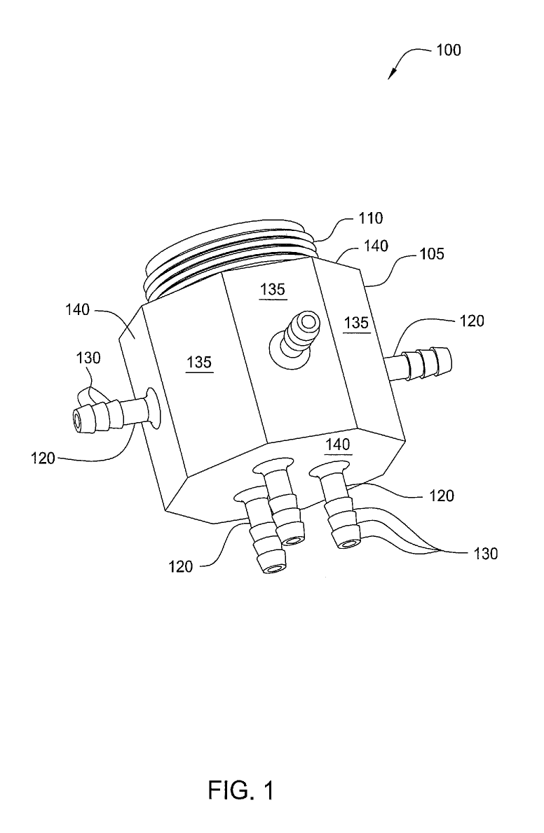

FIG. 1 is a perspective view of one embodiment of an apparatus 100 for improving water circulation, according to the present invention. As illustrated, the apparatus 100 generally comprises a hollow body 105 to which one or more ports 120 are attached (e.g., molded). The body 105 has a generally polyhedronal shape, i.e., the shape is three-dimensional, with multiple flat, polygonal faces 135 and 140 (only some of which are visible in FIG. 1 due to perspective). In the embodiment illustrated in FIG. 1, the faces 135 and 140 are arranged in the form of an octagonal prism, i.e., such that the body 105 has two planar octagonal bases 140 spaced apart from each other by eight planar rectangular sidewalls 135. Thus, hereinafter, the reference numeral 135 may be used to refer to either a “face” of the body 105 or more specifically to a “rectangular sidewall” of the body 105; the reference numeral 140 may be used to refer to either a “face” of the body 105 or more specifically to an “octagonal base” of the body 105. Where a specific face (i.e., a rectangular sidewall or an octagonal base) is intended, the more specific nomenclature will be used.

In other embodiments, the faces 135 and 140 could be arranged to form polyhedrons having other cross sectional shapes (e.g., tetrahedron, dodecahedron, hexagonal prism, etc.). As a further example, a body 105 taking the shape of an octagonal prism may have dimensions of approximately 2.5 inches across the widest portions of the octagonal bases and 2 inches along the longest dimensions of the rectangular sidewalls.

At least one of the faces 135 and 140 (e.g., one of the octagonal bases 140 in the case of the apparatus 100 illustrated in FIG. 1) includes a locking mechanism 110 attached thereto, e.g., via an aperture in the face 135 or 140. In one embodiment, the locking mechanism 110 is a hollow threaded mechanism. The locking mechanism 110 is used to fasten the apparatus 100 to an existing swimming pool pipe system.

In addition, at least one of the faces 135 and 140 includes a port 120 affixed thereto, e.g., via an aperture in the face 135 or 140. In one embodiment, the ports 120 have hollow, substantially tubular shapes including an inlet and an outlet, as discussed in further detail below. In one embodiment, a plurality of ports 120 is placed strategically around the body 105 to increase water flow distribution. In this embodiment, some of the ports 120 may be affixed to the rectangular sidewalls 135 of the body 105, away from locking mechanism 110. For instance, one port 120 may be affixed to every other rectangular sidewall 135, as illustrated in FIG. 1. In a further example of this embodiment, some of the ports 120 may also be affixed to one of the octagonal bases 140 (i.e., the base 140 opposite from the base 140 to which the locking mechanism 110 is attached). For instance, in the example illustrated in FIG. 1, three additional ports 120 are affixed to the base 140 opposite from the base 140 to which the locking mechanism 110 is attached. In one embodiment, the ports 120 that are affixed to the base 140 are placed approximately ⅞ of an inch apart in a triangle pattern (e.g., where each vertex of the triangle is demarcated by a port 120). In one embodiment, the ports 120 may have one or more ridges 130 applied to them, such that portions of the ports 120 are corrugated. The ridges 130 are designed to secure tubing attachments to ports 120.

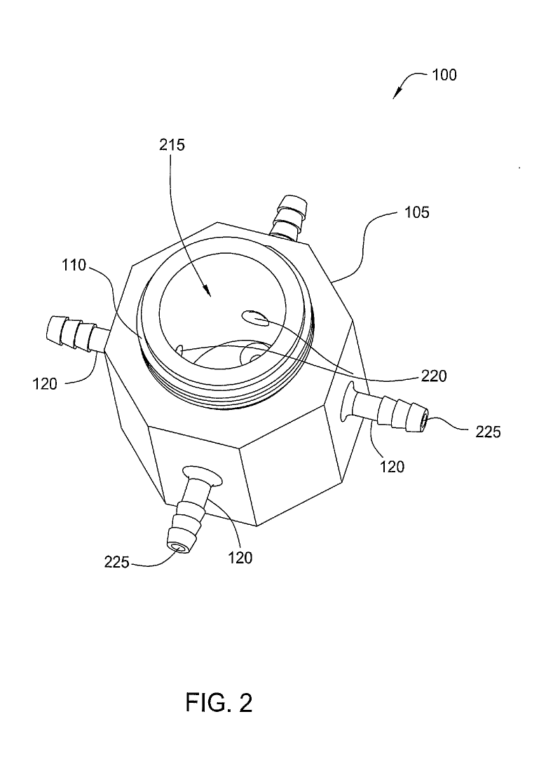

FIG. 2 is another perspective view of the apparatus 100 illustrated in FIG. 1. The perspective of FIG. 2 is positioned to show the direction of water flow 215 through the apparatus 100 when in use. The water is pressurized and flows into the body 105, through inlet apertures 220 of the ports 120, and exits through outlet apertures 225 of the ports 120. A threaded locking mechanism 110 is used to fasten the apparatus 100 to an existing swimming pool pipe threading system.

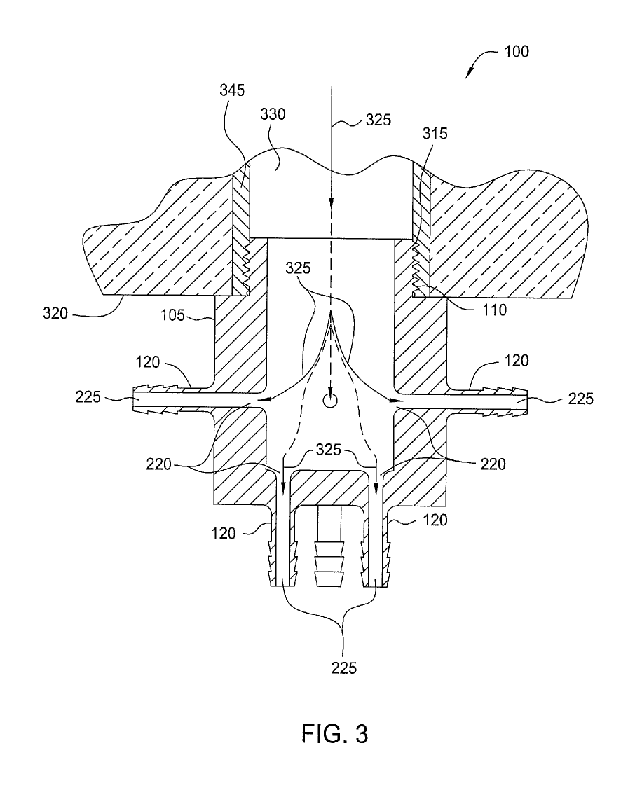

FIG. 3 is a cross sectional view of the apparatus 100 illustrated in FIG. 1. In particular, FIG. 3 illustrates the apparatus 100 fastened to an existing swimming pool piping system 345. As illustrated, when fastened to the piping system 345, the apparatus 100 sits substantially flush with the swimming pool wall 320. A threaded locking mechanism 110 is directly fastened to a threading mechanism 315 of the piping system 345. Pressurized water 325 flows through the existing swimming pool piping system 345, into the hollow body 105 of the apparatus 100, through the inlet aperture(s) 220 of the ports 120, and then out through the outlet aperture(s) 225 of the ports 120. Thus, a fluid passage is defined through the body 105 and the ports 120 and allows water flow to be distributed in a plurality of different directions.

Thus, as the water flow is distributed in multiple different directions, it agitates the water in the swimming pool and forces leaves and dirt debris up to the surface of the water. The leaves and dirt debris can then float into the swimming pool skimmer filtering system. Some swimming pools may have multiple pool outlets, so more than one of the apparatus 100 could be used. Some pools may also include multiple skimming filtering systems too, including a bottom drain. The skimmer filtering system catches most of the large leaves and pieces of dirt debris in a mesh basket that can easily be cleaned by hand. From there, the water flows through the swimming pool water pump and into a filtration system where the water is cleaned thoroughly. The water then flows back into the pool through a piping system to the apparatus 100 (and possibly other diverters), then back into the swimming pool. The process is then repeated.

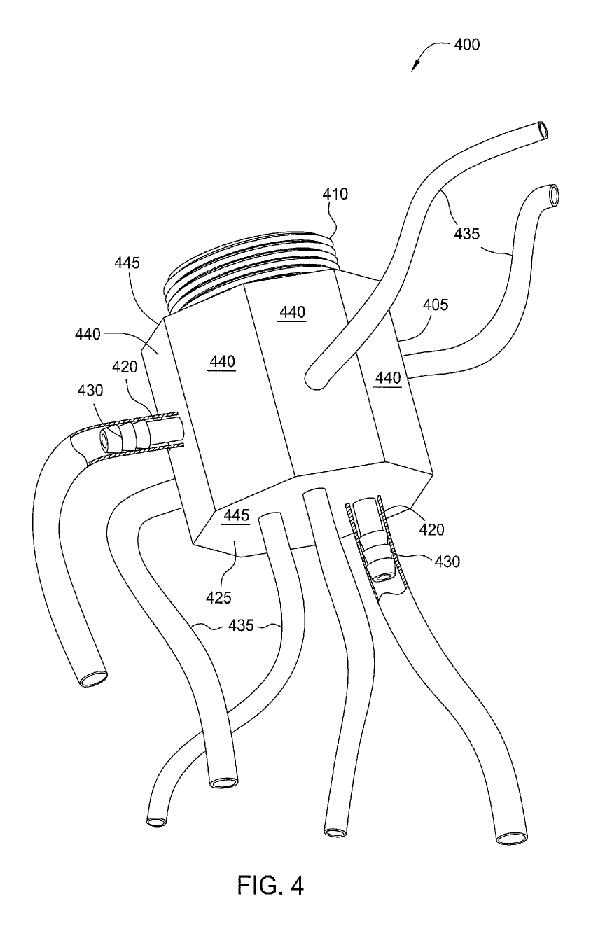

FIG. 4 is a perspective view of a second embodiment of an apparatus 400 for improving water circulation, according to the present invention. The apparatus 400 is substantially similar to the apparatus 100 illustrated in FIG. 1 and comprises a generally polyhedronal body 405 to which one or more ports 420 are attached (e.g., molded). As above, the body 405 has a generally polyhedronal shape, i.e., the shape is three-dimensional, with multiple flat, polygonal faces 440 and 445 (only some of which are visible in FIG. 4 due to perspective). In the embodiment illustrated in FIG. 4, the faces 440 and 445 are arranged in the form of an octagonal prism, i.e., such that the body 405 has two planar octagonal bases 445 spaced apart from each other by eight planar rectangular sidewalls 440. Thus, hereinafter, the reference numeral 440 may be used to refer to either a “face” of the body 405 or more specifically to a “rectangular sidewall” of the body 405; the reference numeral 445 may be used to refer to either a “face” of the body 405 or more specifically to an “octagonal base” of the body 405. Where a specific face (i.e., a rectangular sidewall or an octagonal base) is intended, the more specific nomenclature will be used.

In other embodiments, the faces 440 and 445 could be arranged to form polyhedrons having other cross sectional shapes (e.g., tetrahedron, dodecahedron, hexagonal prism, etc.). As a further example, a body 405 taking the shape of an octagonal prism may have dimensions of approximately 2.5 inches across the widest portions of the octagonal bases and 2 inches along the longest dimensions of the rectangular sidewalls.

At least one of the faces 440 and 445 (e.g., one of the octagonal bases 445 in the case of the apparatus 400 illustrated in FIG. 4) includes a locking mechanism 410 attached thereto, e.g., via an aperture in the face 440 or 445. In one embodiment, the locking mechanism 410 is a hollow, threaded mechanism. The locking mechanism 410 is used to fasten the apparatus 400 to an existing swimming pool pipe system.

In addition, at least one of the faces 440 and 445 includes a port 420 affixed thereto, e.g., via an aperture in the face 440 or 445. In one embodiment, the ports 420 have hollow, substantially tubular shapes including an inlet and an outlet, similar to the ports 120 discussed above. In one embodiment, a plurality of ports 420 is placed strategically around the body 405 to increase water flow distribution. In this embodiment, some of the ports 420 may be affixed to the rectangular sidewalls 440 of the body 405, away from locking mechanism 410. For instance, one port 420 may be affixed to every other rectangular sidewall 440, as illustrated in FIG. 4. In a further example of this embodiment, some of the ports 420 may also be affixed to one of the octagonal bases 445 (i.e., the base 445 opposite from the base 445 to which the locking mechanism 410 is attached). For instance, in the example illustrated in FIG. 4, three additional ports 420 are affixed to the base 445 opposite from the base 445 to which the locking mechanism 410 is attached. In one embodiment, the ports 420 that are affixed to the base 445 are placed approximately ⅞ of an inch apart in a triangle pattern (e.g., where each vertex of the triangle is demarcated by a port 420). In one embodiment, the ports 420 may have one or more ridges 430 applied to them, such that portions of the ports 420 are corrugated.

Unlike the apparatus 100 illustrated in FIG. 1, the apparatus 400 additionally includes tubing 435 removably connected to the corrugated ports 420 and secured firmly in place by the ridges 430. The tubing 435 may be, for example, vinyl tubing. The individual tubes are not necessarily all of the same length; the individual tubes can vary in length as needed. For instance, each of the individual tubes may have a length that is anywhere between 2 and 8 feet in length, although other lengths are possible. This will allow the tubing 435 to move through the water and against one another to push leaves and dirt debris to the top surface of the water. The leaves and dirt debris can then be filtered by the swimming pool skimmer and filtration system.

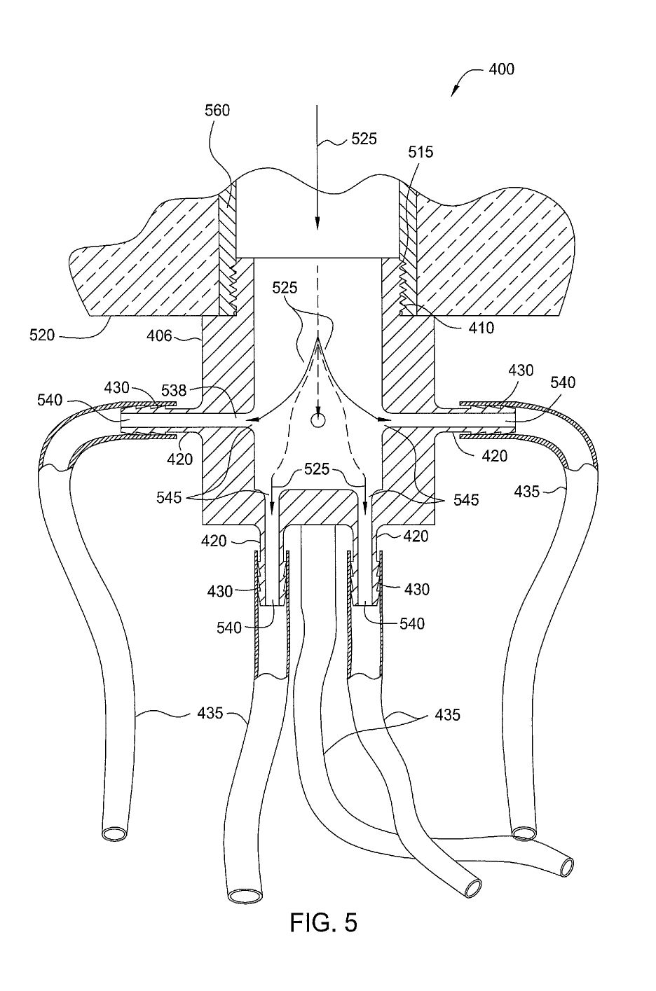

FIG. 5 is a cross sectional view of the apparatus 400 illustrated in FIG. 4. In particular, FIG. 5 illustrates the apparatus 400 fastened to an existing swimming pool piping system 560. As illustrated, when fastened to the existing swimming pool piping system 560, the apparatus 400 sits substantially flush with the swimming pool wall 520. A threaded locking mechanism 410 is directly fastened to a threading mechanism 515 of the piping system 560. Pressurized water 525 flows through the existing swimming pool piping system 560, into the hollow body 405 of the apparatus 400, through inlet aperture(s) 545 of the ports 420, through outlet apertures(s) 540 of the ports 420, and then through the tubing 435. Thus, a fluid passage is defined through the body 405, the ports 420, and the tubing 435. When the pressurized water flows through the tubing 435, the individual tubes are free to fluctuate through the water and against one another.

Although various embodiments which incorporate the teachings of the present invention have been shown and described in detail herein, those skilled in the art can readily devise many other varied embodiments that still incorporate these teachings.

1. An apparatus, comprising:
a hollow body having a polyhedronal shape, the polyhedronal shape comprising a plurality of faces; and
at least one port affixed to one of the plurality of faces, the at least one port including an inlet and an outlet,
wherein a fluid passage is defined through the hollow body and the at least one port.

2. The apparatus of claim 1, wherein the plurality of faces is arranged to form an octagonal prism, the octagonal prism comprising:
a first base having a planar octagonal shape;
a second base having a planar octagonal shape; and
eight planar rectangular sidewalls positioned between the first base and the second base.

3. The apparatus of claim 1, further including:
a locking mechanism affixed to one of the plurality of faces other than the one of the plurality of faces to which the at least one port is affixed.

4. The apparatus of claim 3, wherein the locking mechanism is a hollow threaded mechanism.

5. The apparatus of claim 1, wherein the at least one port has a hollow tubular shape.

6. The apparatus of claim 5, wherein at least a portion of the tubular shape includes at least one ridge.

7. The apparatus of claim 1, further comprising:
at least one piece of tubing coupled to the body via the at least one port.

8. The apparatus of claim 7, wherein the at least one piece of tubing comprises a plurality of pieces of tubing, and each individual piece of tubing in the plurality of pieces of tubing is removably connected to a separate one of the at least one port.

9. The apparatus of claim 8, wherein at least two pieces of tubing in the plurality of pieces of tubing have different lengths.

10. An apparatus, comprising:
a body, comprising:
a first planar base;
a second planar base; and
a plurality of planar sidewalls positioned between the first planar base and the second planar base, such that the first planar base, the second planar base, and the plurality of planar sidewalls collectively form a hollow polyhedron;
a locking mechanism affixed to the first planar base;
a first plurality of ports affixed to the plurality of planar sidewalls; and
at least one port affixed to the second planar base,
wherein a fluid passage is defined through the body, the plurality of ports, and the at least one port.

11. The apparatus of claim 10, wherein the polyhedron is an octagonal prism.

12. The apparatus of claim 10, wherein the locking mechanism is a hollow threaded mechanism.

13. The apparatus of claim 10, wherein the at least one port comprises a second plurality of ports.

14. The apparatus of claim 10, wherein the at least one port and each port of the first plurality of ports has a tubular shape.

15. The apparatus of claim 14, wherein the tubular shape includes at least one ridge.

16. The apparatus of claim 10, further comprising:
at least one piece of tubing coupled to the body via at least one of: the at least one port or the first plurality of ports.

17. The apparatus of claim 16, wherein the at least one piece of tubing comprises a plurality of pieces of tubing, and each individual piece of tubing in the plurality of pieces of tubing is removably connected to a separate one of the at least one port and the first plurality of ports.

18. The apparatus of claim 17, wherein at least two pieces of tubing in the plurality of pieces of tubing have different lengths.

19. An apparatus, comprising:
a body, comprising:
a first planar octagonal base;
a second planar octagonal base; and
a plurality of planar rectangular sidewalls positioned between the first planar octagonal base and the second planar octagonal base, such that the first planar octagonal base, the second planar octagonal base, and the plurality of planar rectangular sidewalls collectively form a hollow octagonal prism;
a locking mechanism affixed to the first planar octagonal base;
a first plurality of ports affixed to the plurality of planar rectangular sidewalls; and
a second plurality of ports affixed to the second planar octagonal base,
wherein a fluid passage is defined through the body, the plurality of ports, and the at least one port.

20. The apparatus of claim 19, further comprising:
a piece of tubing connected to each port in the first plurality of ports and the second plurality of ports.
